(19) United States
(12) Patent Application Publication
(10) Pub. No.: US 2026/0222781 A1
(43) Pub. Date: Jul. 30, 2026

(54) Electronic Devices and Corresponding Methods for Mapping Companion Electronic Devices Using Peer-to-Peer Wireless Communication

(71) Applicant: Motorola Mobility LLC, Chicago, IL (US)

(72) Inventors: Amit Kumar Agrawal, Bangalore (IN); Ranjeet Gupta, Aurora, IL (US); Vishwanath K M, Bangalore (IN)

(21) Appl. No.: 19/039,630

(22) Filed: Jan. 28, 2025

(51) Int. Cl. H04W 4/80; G06F 3/0346; G06F 3/14; H04M 1/72412

(52) U.S. Cl. CPC H04W 4/80; G06F 3/0346; G06F 3/1454; H04M 1/72412

(57) ABSTRACT

Electronic devices and methods are provided for mapping companion devices using peer-to-peer wireless communication. In one or more embodiments, a method in an electronic device involves determining, by one or more processors using a Bluetooth channel sounding process, a location of companion electronic devices. Subsequently, the method involves automatically arranging a mapping of the displays of the companion electronic devices. The one or more processors can control an input control using the mapping. This enhances user experience by eliminating manual adjustments and ensuring seamless interaction.

### BACKGROUND

### TECHNICAL FIELD

This disclosure relates generally to electronic devices, and more particularly to electronic devices having wireless communication devices.

### BACKGROUND ART

Peer-to-peer communication facilitating seamless interaction between electronic devices has become increasingly popular. Peer-to-peer communication protocols such as Bluetooth. sup. TM provides the ability for a single set of user interface devices, such as a keyboard and mouse, to control multiple electronic devices, thereby enhancing productivity and streamlining workflows. While such local area communication protocols work well in practice, they frequently require manual configuration to position and pair electronic devices together, which is both cumbersome and time-consuming. Moreover, when electronic devices are repositioned, reconfiguration can again be required. It would be advantageous to have improved electronic devices and corresponding methods for managing devices using peer-to-peer wireless communication.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory system in accordance with one or more embodiments of the disclosure.

FIG. 2 illustrates one explanatory electronic device in accordance with one or more embodiments of the disclosure.

FIG. 3A illustrates another explanatory system operating in accordance with one or more method steps with one or more embodiments of the disclosure.

FIG. 3B illustrates the explanatory system of FIG. 3 A operating in accordance with one or more other method steps with one or more embodiments of the disclosure.

FIG. 3C illustrates the explanatory system of FIG. 3 A operating in accordance with still other method steps with one or more embodiments of the disclosure.

FIG. 3D illustrates the explanatory system of FIG. 3 A operating in accordance with yet other method steps with one or more embodiments of the disclosure.

FIG. 4 illustrates one explanatory method in accordance with one or more embodiments of the disclosure.

FIG. 5 illustrates one or more method steps in accordance with one or more embodiments of the disclosure.

FIG. 6 illustrates another explanatory method in accordance with one or more embodiments of the disclosure.

FIG. 7 illustrates still another explanatory method in accordance with one or more embodiments of the disclosure.

FIG. 8 illustrates still another explanatory method in accordance with one or more embodiments of the disclosure.

FIG. 9 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, by one or more processors, that a communication device of the electronic device is electronically in communication with at least a first companion electronic device and a second companion electronic device each situated within an environment of the electronic device, determining, by the one or more processors using a Bluetooth channel sounding process performed by the communication device, a location of the first companion electronic device relative to the second companion electronic device, automatically arranging, by the one or more processors, a mapping of a first display of the first companion electronic device and a second display of the second companion electronic device using the location of the first companion electronic device relative to the second companion electronic device, and controlling, by the one or more processors, an input control operable on both the first companion electronic device and the second companion electronic device using the mapping. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to cause a communication device of the electronic device to perform a Bluetooth channel sounding process with a first Bluetooth module asymmetrically situated in a first companion electronic device and a second Bluetooth module situated in a second companion electronic device to determine a location of one of the first companion electronic device or the second companion electronic device relative to another of the first companion electronic device or the second companion electronic device, create a mapping of a first display of the first companion electronic device and a second display of the companion electronic device using the location, and control a pointer using the mapping as described herein. The non-processor circuits may include, but are not limited to, a radio receiver, a radio transmitter, signal drivers, clock circuits, power source circuits, and user input devices.

As such, these functions may be interpreted as steps of a method to perform creating, by one or more embodiments, a mapping of at least a first display of a first companion electronic device and a second display of a second companion electronic device using a Bluetooth channel sounding process to determine a location of the first companion electronic device relative to the second companion electronic device and using, by the one or more processors, the mapping to both cause the cursor to move from the first companion electronic device to the second companion electronic device in response to movement of the electronic device and to change a size of the cursor when the cursor moves from the first companion electronic device to the second companion electronic device. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Peer-to-peer wireless electronic communication, such as that provided by the Bluetooth protocol, provides the ability to control multiple devices with a single user interface. Illustrating by example, a user may have a mouse and keyboard that control a computer and its corresponding display. At the same time, the user may position a tablet computer near the primary display of the computer to “expand” the display area by using the tablet computer as an extension of the primary computer. Using peer-to-peer communication the mouse can, for example, control a pointer that moves seamlessly across the two displays.

In such a “universal control” environment, a significant problem arises when the relative position of the tablet computer and the primary display of the computer change, the universal control feature can become inoperable since the “extension” of the display now extends from a different edge of the primary display. Moving the pointer off the primary display as before causes it to hit a wall. This continues until a user makes manual adjustments to the settings. This manual reconfiguration is cumbersome and disrupts the seamless interaction intended by the universal control setup.

Advantageously, embodiments of the disclosure solve this problem by automatically detecting the relative positions of the various devices using peer-to-peer communication. Illustrating by example, in one or more embodiments one or more processors of an electronic device determine, using a Bluetooth channel sounding process performed by a communication device, a location of a first companion electronic device relative to a second companion electronic device. In one or more embodiments, the one or more processors automatically arrange a mapping of a first display of the first companion electronic device and a second display of the second companion electronic device using the location of the first companion electronic device relative to the second companion electronic device. In one or more embodiments, the one or more processors then control an input control, examples of which include a cursor or pointer, on both the first companion electronic device and second companion electronic device using the mapping. Advantageously, this eliminates the need for manual setting changes and ensures continuous operability regardless of the relative placement of one device to another.

In one or more embodiments, a method in an electronic device provides a solution to the problem of manual configuration in a universal control environment. In one or more embodiments, this involves leveraging Bluetooth channel sounding to automatically determine the relative position of a mobile device, such as a phone or tablet, in relation to a primary device, such as a computer.

In one or more embodiments, this is achieved by utilizing the fixed location of the Bluetooth chip within the computer, which allows for precise distance measurement between the devices. In one or more embodiments, the process begins with a one-time calibration phase where the relative placement of the mobile device is tagged based on the distance from the laptop, using Bluetooth channel sounding frames. In one or more embodiments, this calibration creates a mapping of potential device positions—left, right, top, and bottom—relative to the primary device.

Once calibrated, in one or more embodiments the system enters an autodetection phase where monitoring of the Bluetooth channel sounding frames occurs to detect any displacement of the mobile device. Upon detecting a change, the system automatically updates the mapping and adjusts the input control, such as a mouse or cursor, to ensure seamless interaction across devices. This approach eliminates the need for manual setting changes, thereby maintaining operability and enhancing user experience in a multi-device setup.

In one or more embodiments, an electronic device is equipped with a communication device and one or more processors that operate in conjunction with the communication device. In one or more embodiments, the processors are configured to execute a Bluetooth channel sounding process with a first Bluetooth module asymmetrically positioned in a first companion electronic device and a second Bluetooth module located in a second companion electronic device.

In one or more embodiments, this process determines the relative location of the first companion electronic device in relation to the second companion electronic device. Utilizing this location information, the processors create a mapping of a first display associated with the first companion electronic device and a second display associated with the second companion electronic device. The processors then control a pointer using this mapping, allowing seamless interaction across the displays of the companion electronic devices. This configuration facilitates an intuitive and automated approach to managing the relative positioning of electronic devices, enhancing user experience by eliminating the need for manual configuration.

The arrangement of asymmetrically situated Bluetooth modules enables precise determination of the relative positions of the companion devices. This spatial awareness allows the system to automatically map the displays of the companion devices, facilitating seamless interaction across multiple screens without manual configuration. By controlling a pointer based on this mapping, the system ensures that user input is accurately directed to the intended device, enhancing the fluidity of multi-device interaction.

This approach addresses the problem of manual reconfiguration when devices are repositioned, maintaining continuous operability and improving user experience. The use of Bluetooth channel sounding for spatial determination is a novel application that leverages existing hardware to solve a common issue in multi-device environments, providing a practical and efficient solution.

Embodiments of the disclosure contemplate that in today's technological landscape, seamless interaction between various electronic devices is increasingly sought after. Users often desire the ability to control multiple devices using a single set of input peripherals, such as a keyboard and mouse, to enhance productivity and streamline workflows. However, existing solutions often require manual configuration to establish the relative positioning of these devices, which can be cumbersome and time-consuming. This manual setup is particularly problematic when devices are moved or repositioned, as repeated adjustments are needed to maintain functionality.

Current methods for managing device interaction typically involve static configurations that do not account for dynamic changes in device placement. This limitation can lead to inefficiencies and interruptions in user experience, as the system may become inoperable if devices are not manually reconfigured. Embodiments of the disclosure contemplate there is thus a need for a more intuitive and automated approach to managing the relative positioning of devices is evident, as such an approach would significantly enhance the ease of use and fluidity of interaction in multi-device environments.

Embodiments of the disclosure address these challenges by providing a method and system for automatically determining the relative positions of electronic devices using peer-to-peer wireless communication, specifically leveraging Bluetooth channel sounding. Bluetooth channel sounding is a technique used to measure the distance between two devices that are connected via Bluetooth.

To explain Bluetooth channel sounding, imagine a person has a smartphone and a laptop, and this person wants to know how far apart they are from each other. Bluetooth channel sounding helps achieve this by sending specific signals, called “sounding frames,” between the devices. Here's how the process functions in basic terms (with examples):
Signal Exchange: The devices send and receive these sounding frames to one another. Think of this process like playing a game of catch with a ball, where the ball represents the signal.
Time Measurement: By measuring how long the signal takes to travel from one device to the other and back, the devices can calculate the distance between them. This is similar to estimating the distance of a thunderstorm by counting the seconds between seeing lightning and hearing thunder.
Accuracy: This method is quite precise, often able to determine distances with an accuracy of less than five centimeters (about two inches).

In the context of the technology, Bluetooth channel sounding is used to automatically figure out where a phone or tablet is placed relative to a computer. This helps the devices work together seamlessly without needing manual adjustments, like when one moves a phone from one side of your laptop to the other.

Embodiments of the disclosure use Bluetooth channel sounding in a method in an electronic device that involves creating a mapping of at least a first display of a first companion electronic device and a second display of a second companion electronic device. In one or more embodiments, this mapping is achieved using a Bluetooth channel sounding process to determine the location of the first companion electronic device relative to the second companion electronic device.

In one or more embodiments, the method further includes utilizing the mapping to facilitate the movement of a cursor from the first companion electronic device to the second companion electronic device in response to the movement of the electronic device. Additionally, the method can involve adjusting the size of the cursor as the cursor transitions from the first display to the second display, thereby ensuring a seamless and intuitive user experience across multiple devices.

Advantageously, this approach leverages the spatial awareness provided by Bluetooth channel sounding to automate the configuration of device interactions, enhancing the fluidity and efficiency of multi-device environments. Moreover, this approach advantageously allows for the automatic arrangement of device displays and control of input peripherals, such as a cursor or pointer, across multiple devices without the need for manual configuration. By utilizing the fixed location of Bluetooth modules within devices, the described method enables precise distance measurement and mapping of device positions, ensuring seamless interaction and continuous operability regardless of device placement changes.

Other advantages offered by embodiments of the disclosure will be described below. Still others will be obvious to those of ordinary skill in the art having the benefit of this disclosure.

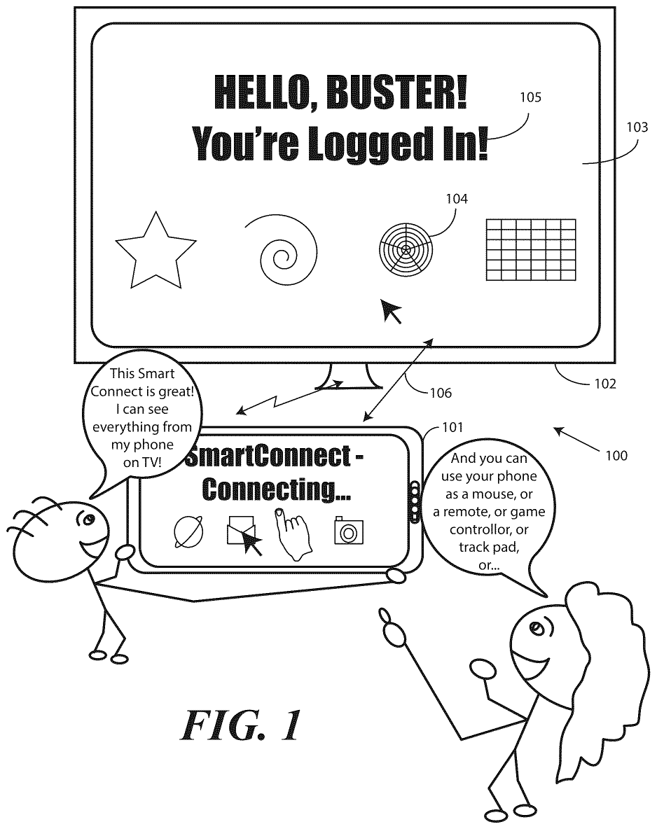

Turning now to FIG. 1, illustrated therein is one explanatory system 100 configured in accordance with one or more embodiments of the disclosure illustrating an electronic device 101 operating in conjunction with a content presentation companion device 102 in accordance with one or more embodiments of the disclosure. In FIG. 1, the electronic device 101 and the content presentation companion device 102 operate in tandem as a system, with the electronic device 101 providing the processing power while the content presentation companion device 102 serves as a primary display device for the electronic device 101.

As shown in FIG. 1, the electronic device 101 is electronically in communication with the content presentation companion device 102. As such, the content presentation companion device 102 is a “companion electronic device” of the electronic device 101.

When the electronic device 101 is electronically in communication with the content presentation companion device 102 as a companion electronic device, this allows the electronic device 101 to use the larger display 103 of the companion electronic device 300 to present content. Illustrating by example, in one or more embodiments the electronic device 101 can operate in a “content redirection” mode by presenting content such as movies, videos, images, and even a traditional computer user interface, on the display 103 of the content presentation companion device 102.

Embodiments of the disclosure contemplate that with the advanced computing power available in smartphones and other electronic devices, users often consume movies, videos, television shows, and other content using these devices. Additionally, they can perform work operations such as sending email, managing files, working on documents and spreadsheets, and so forth.

By establishing an electronic communication channel 106 between the electronic device 101 and the content presentation companion device 102, the processing power of the electronic device 101 can be leveraged to present content on the display 103 of the content presentation companion device 102. This allows a user to watch television, play video games, work on homework or office work, video call friends and family, or perform other tasks using the one or more processors of the electronic device 101 combined with the large display 103 of the content presentation companion device 102.

Using a content redirection feature, a small electronic device 101 such as the smartphone shown in FIG. 1 can connect to connect to a content presentation companion device 102 such as a larger monitor, television, or other device having a larger screen. Using the content redirection feature, users can wirelessly stream video content to the larger display 103 of the content presentation companion device 102 with no loss in performance. Resolution of the images 104 on the content presentation companion device 102 can be as high as 4K with frame rates that present the content 105 without flicker or distortion. In the illustrative embodiment of FIG. 1, neither a cable nor a docking station is required to use the content redirection feature.

When using the content redirection feature, the electronic device 101 can function as a mouse, trackpad, or other control device while the content 105 is being presented on the content presentation companion device 102. The content redirection feature can be used for presenting pictures, videos, television shows, or movies on the larger display 103 of a content presentation companion device 102. Additionally, it can be used for gaming, video conferences, and other content presentation tasks.

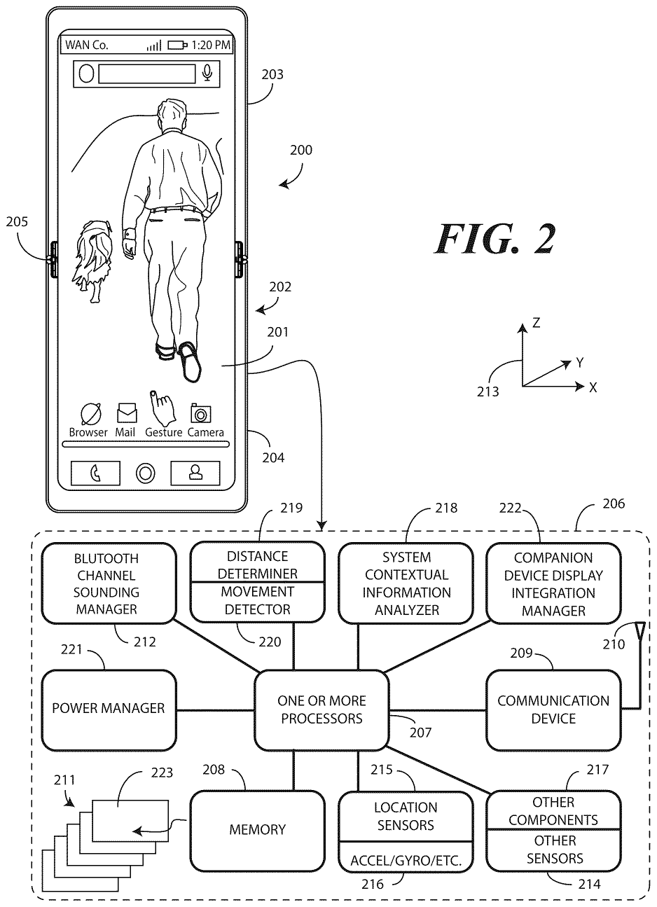

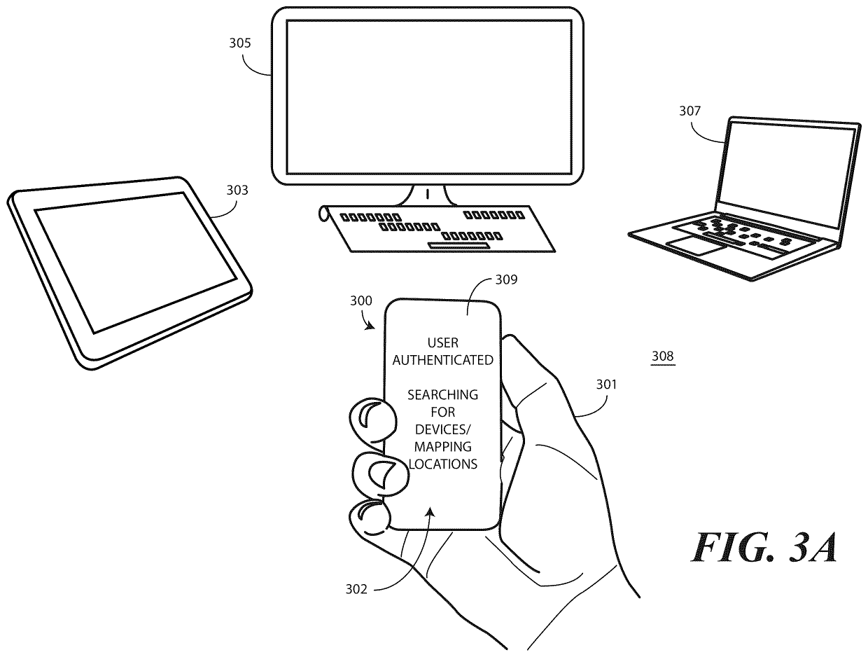

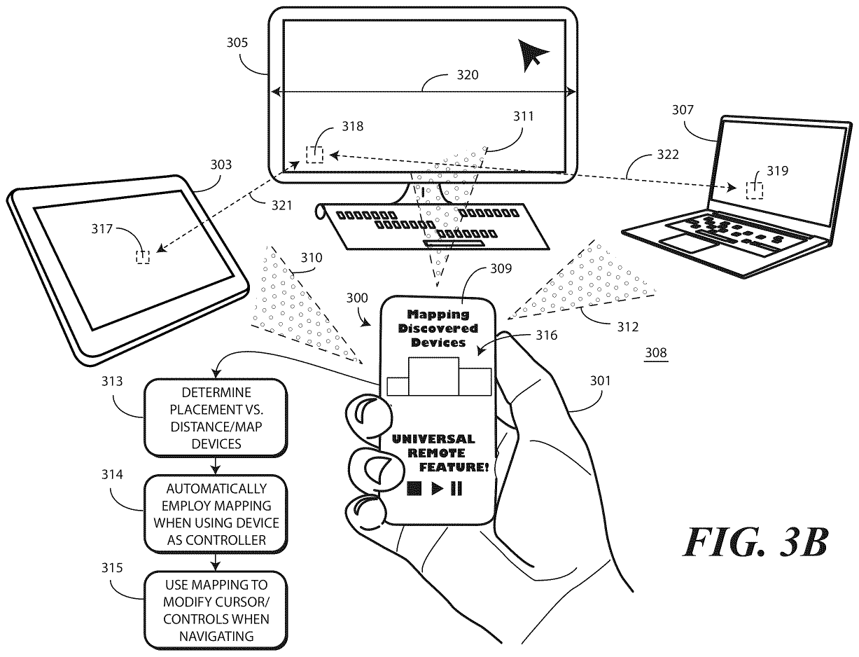

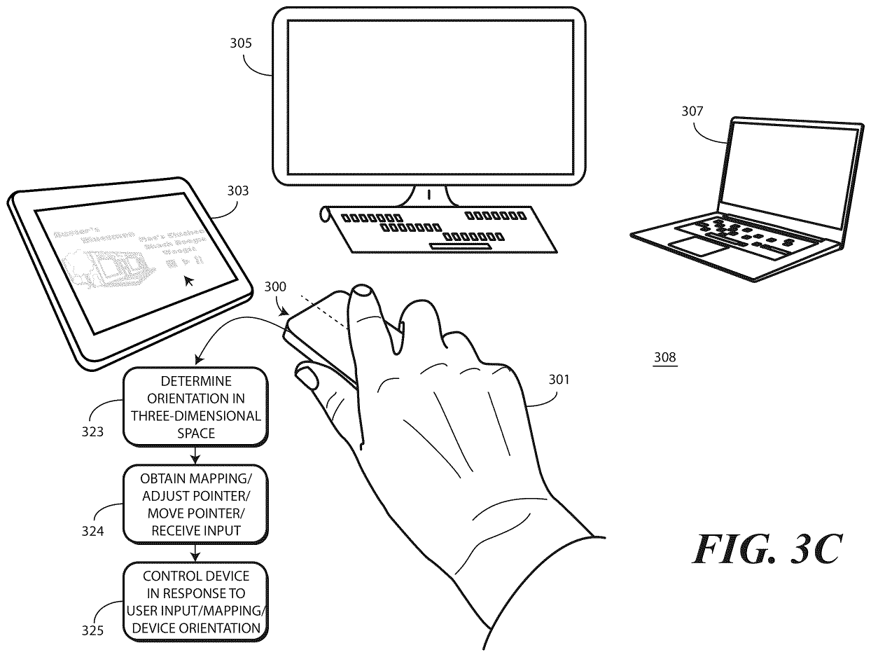

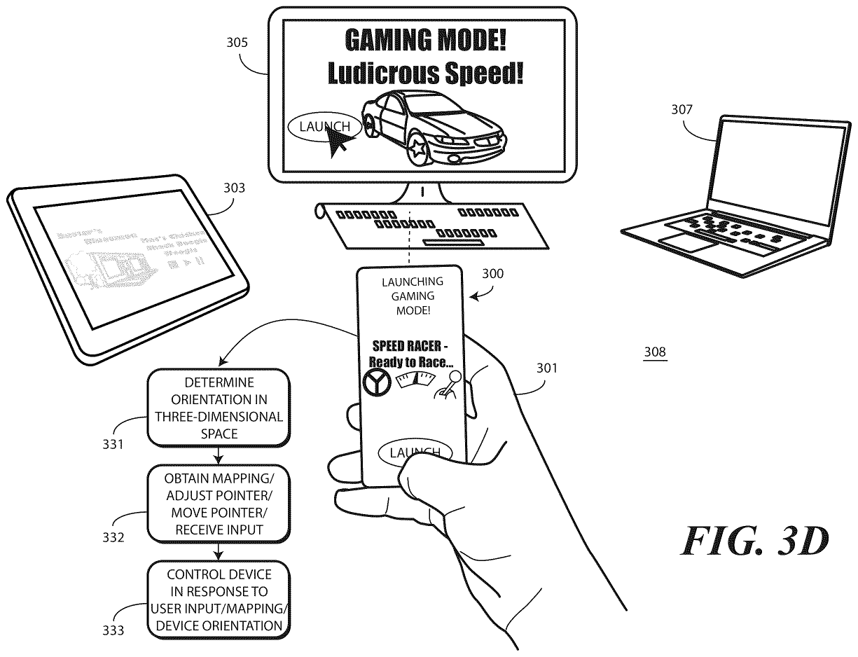

Embodiments of the disclosure advantageously provide a more intelligent system that dynamically enhances a user interface defined by multiple companion electronic devices, especially when operating in conjunction with the content redirection feature. Such a system will be described in detail below with reference to FIGS. 3A-3D. However, before turning to the user interface enhancements and how they are provided a deeper look into the hardware of the electronic device 101 will be provided. Turning now to FIG. 2, illustrated therein is one explanatory electronic device 200 configured in accordance with one or more embodiments of the disclosure.

The electronic device 200 of FIG. 2 is a portable electronic device and is shown as a smartphone for illustrative purposes. However, it should be obvious to those of ordinary skill in the art having the benefit of this disclosure that other electronic devices may be substituted for the explanatory smart phone of FIG. 2. For example, the electronic device 200 could equally be a conventional desktop computer, palm-top computer, a tablet computer, a gaming device, a media player, or other device.

This illustrative electronic device 200 includes a display 201, which may optionally be touch-sensitive. Users can deliver user input to the display 201, which serves as a user interface for the electronic device 200. In one embodiment, users can deliver user input to the display 201 of such an embodiment by delivering touch input from a finger, stylus, or other objects disposed proximately with the display 201. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 200 of FIG. 2 also includes a device housing 202. In one embodiment, the device housing 202 includes two housing members, namely, a first device housing 203 that is coupled to a second device housing 204 by a hinge 205 such that the first device housing 203 is pivotable about the hinge 205 relative to the second device housing 204 between a closed position and an axially displaced open position. In other embodiments, such as that associated with the electronic device (101) of FIG. 1, the device housing 202 will be rigid and will include no hinge.

In still other embodiments, the device housing 202 will be manufactured from a flexible material such that it can be bent and deformed. Where the device housing 202 is manufactured from a flexible material or where the device housing 202 includes a hinge, the display 201 can be manufactured on a flexible substrate such that it bends. In one or more embodiments, the display 201 is configured as a flexible display that is coupled to the first device housing 203 and the second device housing 204, spanning the hinge 205. Features can be incorporated into the device housing 202, including control devices, connectors, and so forth.

Also shown in FIG. 2 is an explanatory block diagram schematic 206 of the explanatory electronic device 200. In one or more embodiments, the block diagram schematic 206 is configured as a printed circuit board assembly disposed within the device housing 202 of the electronic device 200. Various components can be electrically coupled together by conductors or a bus disposed along one or more printed circuit boards.

The illustrative block diagram schematic 206 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

In one embodiment, the electronic device includes one or more processors 207. In one embodiment, the one or more processors 207 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 206.

Each of the application processor and the auxiliary processor(s) can be configured to process and execute executable software code to perform the various functions of the electronic device with which the block diagram schematic 206 operates. A storage device, such as memory 208, can optionally store the executable software code used by the one or more processors 207 during operation.

In this illustrative embodiment, the block diagram schematic 206 also includes a communication device 209 that can be configured for wired or wireless communication with one or more other devices or networks. The networks can include a wide area network, a local area network, and/or personal area network. The communication device 209 may also utilize wireless technology for communication, such as, but are not limited to, peer-to-peer or ad hoc communications such as HomeRF, Bluetooth and IEEE 802.11, and other forms of wireless communication such as infrared technology. The communication device 209 can include wireless communication circuitry, one of a receiver, a transmitter, or transceiver, and one or more antennas 210.

In one embodiment, the one or more processors 207 can be responsible for performing the primary functions of the electronic device with which the block diagram schematic 206 is operational. For example, in one embodiment the one or more processors 207 comprise one or more circuits operable with the display 201 to present presentation information to a user. The executable software code used by the one or more processors 207 can be configured as one or more modules 211 that are operable with the one or more processors 207. Such modules 211 can store instructions, control algorithms, and so forth.

In one or more embodiments, the block diagram schematic 206 includes a Bluetooth channel sounding manager 212. In one or more embodiments, the Bluetooth channel sounding manager 212 utilizes the communication device 209 to perform wireless communications with one or more other companion electronic devices that are also configured for Bluetooth communication.

The illustrative Bluetooth channel sounding manager 212 of FIG. 2 is a dedicated Bluetooth transceiver constructed into the electronic device 200 configured to use the one or more antennas 210 or its own antenna structure to communicate, using Bluetooth (BL) or Bluetooth Low Energy (BLE) technology, with another Bluetooth component. In one or more embodiments, the Bluetooth channel sounding manager 212 comprises wireless communication circuitry, one of a receiver, a transmitter, or transceiver, and one or more antennas, which may be separate from, or the same as, the one or more antennas 210 used by the communication device 209.

The inclusion of the Bluetooth channel sounding manager 212 advantageously allows wireless communication with Bluetooth component component connected to or integrated into another electronic device that is fast and secure, all while requiring very little power (especially when using BLE). Bluetooth communication is especially well suited to embodiments of the disclosure because it is configured for short-range communication that is well beyond the typical distance that will occur when an electronic device such as the electronic device 200 of FIG. 2 is being used to control one or more companion electronic devices. Additionally, the accuracy of location, and therefore the accuracy of distance measurements, is within five centimeters or so. This is in contrast to Wi-Fi, which has an accuracy of five to fifteen meters. Bluetooth is also quite reliable.

In one or more embodiments, the Bluetooth channel sounding manager 212 can be used to determine the locations of one or more companion electronic devices relative to the electronic device 200 of FIG. 2. As noted above, Bluetooth channel sounding is a technique used to measure the distance between electronic devices that are connected via Bluetooth. Bluetooth channel sounding helps achieve this by sending specific signals, called “sounding frames,” between the devices.

In the context of the electronic device 200 from FIG. 2, Bluetooth channel sounding can be used to automatically figure out where a Bluetooth-equipped display, Bluetooth-equipped tablet, Bluetooth-equipped computer, or other Bluetooth-equipped device. As will be described below with reference to FIGS. 3A-3D, this helps the devices work together seamlessly without needing manual adjustments. By knowing the exact position of each device, the Bluetooth channel sounding manager 212 can automatically adjust how the electronic device 200 interacts with companion electronic devices. This allows, for example, the seamless movement of a mouse pointer smoothly from one screen of one companion electronic device to another screen of another companion electronic device. This makes using multiple devices together much easier and more intuitive.

Various sensors 214 can be operable with the one or more processors 207. One example of a sensor that can be included with the various sensors 214 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 207, to detect an object in close proximity with - or touching - the surface of the display 201 or the device housing 202 of the electronic device 200 by establishing electric field lines between pairs of capacitive sensors and then detecting perturbations of those field lines.

Another example of a sensor that can be included with the various sensors 214 is a geo-locator that serves as a location detector 215. In one embodiment, location detector 215 is able to determine location data. Location can be determined by capturing the location data from a constellation of one or more earth orbiting satellites, or from a network of terrestrial base stations to determine an approximate location. The location detector 215 may also be able to determine location by locating or triangulating terrestrial base stations of a traditional cellular network, or from other local area networks, such as Wi-Fi networks.

Another example of a sensor that can be included with the various sensors 214 is an orientation detector 216 operable to determine an orientation and/or movement of the electronic device 200 in three-dimensional space 213. Illustrating by example, the orientation detector 216 can include an accelerometer, gyroscopes, or other device to detect device orientation and/or motion of the electronic device 200. Using an accelerometer as an example, an accelerometer can be included to detect motion of the electronic device. Additionally, the accelerometer can be used to sense some of the gestures of the user, such as one talking with their hands, running, or walking.

The orientation detector 216 can determine the spatial orientation of an electronic device 200 in three-dimensional space 213 by, for example, detecting a gravitational direction. In addition to, or instead of, an accelerometer, an electronic compass can be included to detect the spatial orientation of the electronic device 200 relative to the earth's magnetic field. Similarly, one or more gyroscopes can be included to detect rotational orientation of the electronic device 200.

Other components 217 operable with the one or more processors 207 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 217 can also include proximity sensors. The proximity sensors fall into one of two camps: active proximity sensors and “passive” proximity sensors. Either the proximity detector components or the proximity sensor components can be generally used for gesture control and other user interface protocols.

The other components 217 can optionally include a barometer operable to sense changes in air pressure due to elevation changes or differing pressures of the electronic device 200. The other components 217 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 200. Similarly, a temperature sensor can be configured to monitor temperature about an electronic device.

A context engine 218 can then be operable with the various sensors to detect, infer, capture, and otherwise determine persons and actions that are occurring in an environment about the electronic device 200. For example, where included one embodiment of the context engine 218 determines assessed contexts and frameworks using adjustable algorithms of context assessment employing information, data, and events. These assessments may be learned through repetitive data analysis. Alternatively, a user may employ a menu or user controls via the display 201 to enter various parameters, constructs, rules, and/or paradigms that instruct or otherwise guide the context engine 218 in detecting multi-modal social cues, emotional states, moods, and other contextual information. The context engine 218 can comprise an artificial neural network or other similar technology in one or more embodiments.

In one or more embodiments, the context engine 218 is operable with the one or more processors 207. In some embodiments, the one or more processors 207 can control the context engine 218. In other embodiments, the context engine 218 can operate independently, delivering information gleaned from detecting multi-modal social cues, emotional states, moods, and other contextual information to the one or more processors 207. The context engine 218 can receive data from the various sensors 214. In one or more embodiments, the one or more processors 207 are configured to perform the operations of the context engine 218.

In one or more embodiments, the electronic device 200 includes a distance determination manager 219 that is operable with the Bluetooth channel sounding manager 212 to determine a precise location (within five centimeters) of the electronic device 200 in relation to other electronic devices also having Bluetooth capabilities. A motion detector 220 determines when the electronic device 200 moves.

As will be described in more detail below, in one or more embodiments the one or more processors 207 of the electronic device 200 an initialization and calibration phase with other companion electronic devices. In one or more embodiments, when in the initialization and calibration phase the process begins by verifying whether the electronic device 200 is paired or connected via Bluetooth with one or more companion electronic devices.

Once connectivity is confirmed, the in one or more embodiments the one or more processors 207 determine whether a universal control feature, one example of which is the “Smart Connect” system offered by Motorola Mobility and shown in FIG. 1, has been initiated. If calibration of the Bluetooth channel sounding manager 212 is deemed necessary, in one or more embodiments the one or more processors 207 use the user interface to prompt a user to perform a one-time setup.

In one or more embodiments, this setup involves placing a second companion electronic device on the left and right sides of a first companion electronic device. In one or more embodiments, the Bluetooth channel sounding manager 212 then computes the range between the electronic device 200 and the companion electronic devices using Bluetooth channel sounding and tags the respective distances as “Left” or “Right.”

In one or more embodiments, the user is then asked to confirm these placements, ensuring accurate calibration of the Bluetooth channel sounding manager 212. Upon successful confirmation, the calibration process is completed, allowing the Bluetooth channel sounding manager 212 to proceed to the autodetection phase, where adjustments to changes in device positioning occur without further manual intervention, as will be described below.

While Bluetooth communication is very conservative with respect to power consumption, embodiments of the disclosure contemplate that the electronic device 200 can be even more efficient when adjustments to the mapping of the companion electronic devices made by the one or more processors 207 only occur when the distance between the electronic device 200 and the content presentation companion device has changed. Accordingly, in one or more embodiments the mapping is altered or adjusted in response to one or both of the distance determination manager 219 detecting a change in the distance between the electronic device 200 and the companion electronic devices and/or the motion detector 220 determining that the electronic device 200 has moved relative to the companion electronic devices the initial mapping has been made. To that end, a power manager 221 can be configured to ensure that distance measurements, Bluetooth communications, user interface enhancements, and other operations are only performed once the electronic device 200 has moved since the last similar operation was performed.

An optional content presentation companion device integration manager 222 can be operable to perform content redirection operations. In one or more embodiments, the content presentation companion device integration manager 222 allows the one or more processors 207 of the electronic device 200 to connect to a content presentation companion device such as a larger monitor, television, or other device having a larger screen. The content presentation companion device integration manager 222 then facilitates wireless streaming of content to the larger display of a content presentation companion device.

In one or more embodiments, neither a cable nor a docking station is required for the content presentation companion device integration manager 222 to redirect content to another device. Instead, the content presentation companion device integration manager 222 employs the communication device 209 and the one or more antennas 210 to transmit content to a content presentation companion device.

The inclusion of the content presentation companion device integration manager 222 allows the electronic device 200 to be used as a mouse, trackpad, or other control device while content is being presented on the content presentation companion device. The content presentation companion device integration manager 222 can be used for presenting pictures, videos, television shows, or movies on the larger display of a content presentation companion device. Additionally, the content presentation companion device integration manager 222 can facilitate gaming, video conferences, and other content presentation tasks using the display of a content presentation companion device as well.

As described, in one or more embodiments the electronic device 200 is equipped with a communication device 209 and one or more processors 207 operable with the communication device 209. In one or more embodiments, the one or more processors 207 are configured, in conjunction with the Bluetooth channel sounding manager 212, to execute a Bluetooth channel sounding process with at least a first Bluetooth module asymmetrically situated in a first companion electronic device and a second Bluetooth module situated in a second companion electronic device.

In one or more embodiments, this process determines the relative location of the first companion electronic device in relation to the second companion electronic device. Utilizing this location information, in one or more embodiments the one or more processors 207 create a mapping 223 of a first display associated with the first companion electronic device and a second display associated with the second companion electronic device.

In one or more embodiments, the one or more processors 207 then control a pointer using this mapping 223, thereby allowing seamless interaction across the displays of the companion electronic devices. This configuration facilitates an intuitive and automated approach to managing the relative positioning of electronic devices, enhancing user experience by eliminating the need for manual configuration.

In one embodiment, the first Bluetooth module is asymmetrically situated in the first companion electronic device. In one or more embodiments, when this is the case the one or more processors 207 are configured to determine that the location of the first companion electronic device is to the left or the right of the second companion electronic device when a distance between the first Bluetooth module and the second Bluetooth module is greater than half of a diameter of the first companion electronic device.

In another embodiment, the first Bluetooth module is situated in a left side of the first companion electronic device. In one or more embodiments, when this is the case, the processors are configured to determine that the location of the first companion electronic device is to the left of the second companion electronic device when the distance between the first Bluetooth module and the second Bluetooth module is greater than half of the diameter of the first companion electronic device.

Additionally, the explanatory electronic device 200 may include a user interface, one example of which is the display 201 in FIG. 2. In one or more embodiments, the one or more processors 207 are further configured to cause the user interface to present a prompt instructing a user to orient the electronic device 200 to the left and to the right of the first companion electronic device while the Bluetooth channel sounding process is occurring. This can happen during the initialization and calibration phase described above.

Furthermore, in one or more embodiments the one or more processors 207 are configured to change the size of the pointer using the mapping 223 when moving the pointer from the first companion electronic device to the second companion electronic device or vice versa. In some embodiments, a system includes both the first companion electronic device and the second companion electronic device. As will be described below, in one or more embodiments the first companion electronic device comprises a computer and the second companion electronic device comprises one of a tablet computer or a smartphone. An example of such a system will be described below with reference to FIGS. 3A-3D.

It is to be understood that FIG. 2 is provided for illustrative purposes only and for illustrating components of one electronic device 200 in accordance with embodiments of the disclosure and is not intended to be a complete schematic diagram of the various components required for an electronic device. Therefore, other electronic devices configured in accordance with embodiments of the disclosure may include various other components not shown in FIG. 2 or may include a combination of two or more components or a division of a particular component into two or more separate components and still be within the scope of the present disclosure.

Turning now to FIG. 3A, illustrated therein is one explanatory system configured in accordance with one or more embodiments of the disclosure. As shown, an authorized user 301 of an electronic device 300 has positioned the electronic device 300 in an environment 308 with a plurality of companion electronic devices 303,305,307. In this explanatory system, a first companion electronic device 303 is a tablet computer, while a second companion electronic device 305 is a desktop computer. A third companion electronic device 307 is a laptop computer. These examples of companion electronic devices are illustrative only, as others will be obvious to those of ordinary skill in the art having the benefit of this disclosure.

In FIG. 3A, the electronic device 300 establishes Bluetooth communication with the first companion electronic device 303, the second companion electronic device 305, and the third companion electronic device 307 by utilizing an integrated communication device, which is configured for Bluetooth connectivity. Initially, the electronic device 300 initiates a pairing process with each companion electronic device, ensuring that each device is within the effective range for Bluetooth communication.

During this process, the electronic device 300 sends out a Bluetooth signal to discover nearby devices, and upon detecting the first companion electronic device 303, the second companion electronic device 305, and the third companion electronic device 307, a secure connection is established with each device. As shown in FIG. 3A, when this process is occurring, a prompt 302 is presented on the user interface indicating that the authorized user 301 has been authenticated and that a Bluetooth search operation is occurring.

Once the pairing process is complete, in one or more embodiments the communication device within the electronic device 300 employs Bluetooth channel sounding to facilitate precise distance measurement and spatial awareness, allowing for seamless interaction and control across the displays of the companion electronic devices. This setup enables the electronic device 300 to manage input controls, such as a pointer, across the connected devices, thereby enhancing the user experience by providing a fluid and intuitive multi-device environment. Turning now to FIG. 3B, illustrated therein is the electronic device 300 performing this process.

In one or more embodiments, this method in the electronic device 300 involves determining, by one or more processors, that a communication device of the electronic device is electronically in communication with at least a first companion electronic device 303 and a second companion electronic device 305. As shown, each of the first companion electronic device 303, the second companion electronic device 305, and the third companion electronic device 307 are situated within the environment 308 of the electronic device300.

In one or more embodiments, the method further includes determining, by the one or more processors using a Bluetooth channel sounding process 310,311,312 performed by the communication device, a location of the first companion electronic device 303 relative to the second companion electronic device 305 and the location of the second companion electronic device 305 relative to the third companion electronic device 307. Subsequently, the method involves automatically arranging, by the one or more processors, a mapping 316, which is shown on the display 309 of the electronic device 300 in this example, of a first display of the first companion electronic device 303, a second display of the second companion electronic device 305, and a third display of the third companion electronic device 307 using the determined location of the first companion electronic device 303 relative to the second companion electronic device 305 and the location of the second companion electronic device 305 relative to the third companion electronic device 307. As will be illustrated below with reference to FIG. 3C, thereafter the one or more processors can control an input control operable on the first companion electronic device 303, the second companion electronic device 305, and the third companion electronic device 307 using the mapping 316, thereby facilitating seamless interaction across the devices without requiring manual configuration.

Illustrating by example, as shown in FIG. 3B the electronic device 300 executes a first Bluetooth channel sounding process 310 with a first Bluetooth module 317 situated within the first companion electronic device 303, a second Bluetooth channel sounding process 311 with a second Bluetooth module 318 situated within the second companion electronic device 305, and a third Bluetooth channel sounding process 312 with a third Bluetooth module 319 situated within the third companion electronic device 307. In this illustrative embodiment, the second Bluetooth module 318 is “asymmetrically” situated within the second companion electronic device 305 because it is situated in an off-center location relative to the second companion electronic device 318.

In one or more embodiments, this process determines the relative location of each companion electronic device 303,305,307 relative to each other companion electronic device. Illustrating by example, it determines the location of the first companion electronic device 303 in relation to the second companion electronic device 305 and the second companion electronic device 305 in relation to the third companion electronic device 307.

Utilizing this location information, at step 313 the processors create a mapping 316 of a first display associated with the first companion electronic device 303, a second display associated with the second companion electronic device 305, and a third display of the third companion electronic device 307. In one or more embodiments, step 313 only occurs when a universal control for the first companion electronic device and the second companion electronic device has been activated by the authorized user 301 of the electronic device 300 in advance.

In one or more embodiments, step 313 further comprises causing, by the one or more processors, a user interface of the electronic device 300 to display the mapping 316 of the first display of the first companion electronic device 303, the second display of the second companion electronic device 305, and the third display of the third companion electronic device 307. This optional step has been done in FIG. 3B, with the mapping 316 being presented with user interface controls on a display 309 of the electronic device 300.

In the illustrative embodiment of FIG. 3B, the mapping 316 is “bottom justified” in that the bottom edges of each of the first display, the second display, and the third display are collinear, as shown on the display 309 of the electronic device 300. In one or more embodiments, the bottom justified configuration is a default configuration, although top justification or other configurations can be defined to be the default using the user interface of the electronic device 300. Thus, in one or more embodiments step 313 comprises automatically arranging the mapping 316 of the first display of the first companion electronic device and the second display of the second companion electronic device using the location of the first companion electronic device 303 relative to the second companion electronic device 305 using bottom justifying an arrangement of the first display of the first companion electronic device 303 and the second display of the second companion electronic device 305. The same can occur with the arrangement of the third companion electronic device 307 as well.

At step 314, the processors then control a pointer using this mapping 316. This facilitates seamless interaction across the displays of the companion electronic devices 303,305,307. This configuration facilitates an intuitive and automated approach to managing the relative positioning of electronic devices, enhancing user experience by eliminating the need for manual configuration.

As noted above, in this illustrative embodiment the second Bluetooth module 318 is asymmetrically situated in the second companion electronic device 305. In one or more embodiments, at step 313 the processors are configured to determine that the location of the first companion electronic device 303 is to the left or the right of the second companion electronic device 305 when a distance 321 between the first Bluetooth module 317 and the second Bluetooth module 318 is greater than half of a diameter 320 of the second companion electronic device 305.

Illustrating by example, in this example, the third companion electronic device 307 is situated to the right of the second companion electronic device 305 while the second Bluetooth module 318 is asymmetrically positioned within the second companion electronic device 305 by being positioned to the left of a vertical medial reference passing through the second companion electronic device 305. Accordingly, the distance 322 between the third Bluetooth module 319 situated in the third companion electronic device 307 is greater than half the diameter 320 of the second companion electronic device 305. The one or more processors of the electronic device 300 thus determine the third companion electronic device 307 is situated to the right of the second companion electronic device 305.

Similarly, the distance 321 between the second Bluetooth module 318 situated in the second companion electronic device 305 and the first Bluetooth module 317 in the first companion electronic device 303 is not greater than half the diameter 320, so the one or more processors can conclude the first companion electronic device 303 is to the left of the second companion electronic device 305. In one or more embodiments, the location of any asymmetrically situated Bluetooth module can be transmitted to the electronic device 300 during the initialization phase. Had the second Bluetooth module 318 been situated on the right side of the second companion electronic device 305, the conclusions illustrated in the mapping 316 would be opposite.

Additionally, the electronic device 300 may include a user interface, one example of which is the display 309 of FIG. 3B. In one or more embodiments, the processors are further configured to cause the user interface to present a prompt 302, as noted above. In one or more embodiments, this prompt 302 instructs the authorized user 301 of the electronic device 300 to orient the electronic device 300 to the left and to the right of the companion electronic devices 303,305,307 while the Bluetooth channel sounding process 31,311,312 is occurring. Furthermore, in one or more embodiments the processors are configured at step 315 to change the size of the pointer using the mapping when moving the pointer from, for example, the first companion electronic device 303 to the second companion electronic device 305 or vice versa.

Thus, to recap to this point, in FIG. 3A the one or more processors of the electronic device 300 determine that a communication device of the electronic device 300 is electronically in communication with at least the first companion electronic device 303 and the second companion electronic device 305, each situated within the environment 308 of the electronic device 300. In FIG. 3B, the one or more processors of the electronic device 300 determine, using a Bluetooth channel sounding process 310,311,312 performed by the communication device, a location of the first companion electronic device 303 relative to the second companion electronic device 305. Moreover, at step 313 the one or more processors of the electronic device 300 automatically arrange a mapping 316 of a first display of the first companion electronic device 303 and a second display of the second companion electronic device 305 using the location of the first companion electronic device 303 relative to the second companion electronic device 305.

Thereafter, at step 314 the one or more processors control an input control, shown illustratively as a pointer on the display of the second companion electronic device 305, using the mapping 316. Illustrating by example, in one or more embodiments the one or more processors of the electronic device 300 determine, from signals received from an orientation detector, a change in orientation of the electronic device 300. In one or more embodiments, when this occurs, step 314 can cause, by the one or more processors, the pointer to appear to move in accordance with the mapping 316 from the first display of the first companion electronic device 303 to the second display of the second companion electronic device 305.

To illustrate this, turn now to FIG. 3C. As shown, the authorized user 301 of the electronic device 300 has rotated the electronic device 300 to the left from the position of FIG. 3B, where a medial line was oriented toward the second companion electronic device 305, to another orientation where the medial line is oriented toward the first companion electronic device 303. At step 323 of FIG. 3C, the orientation detector of the electronic device 300 detects a change in the device's orientation in three-dimensional space, transitioning from a position where the device is directed toward the second companion electronic device 305 to a new orientation pointing toward the first companion electronic device 303.

This change in orientation is facilitated by the orientation detector, which may include components such as accelerometers, gyroscopes, or electronic compasses, capable of sensing the spatial orientation and movement of the electronic device 300. At step 324, the one or more processors of the electronic device 300 control the pointer in accordance with the mapping to move it from the display of the second companion electronic device 305 to the display of the first companion electronic device. The user interface of the first companion electronic device 303 can then be controlled by the pointer in response to user input at step 325.

In one or more embodiments, the one or more processors also control the size of the pointer at step 323. Thus, in one or more embodiments step 324 comprises also causing, by the one or more processors, a resizing of the pointer in accordance with the mapping when the pointer moves from the second display of the second companion electronic device 305 to the first display of the first companion electronic device 303. In this example, the pointer became smaller so as to be less obtrusive on the smaller display of the first companion electronic device 303.

Turning now to FIG. 3D, once the mapping is complete, the authorized user 301 of the electronic device 300 can use the mapping to control the various companion electronic devices 303,305,307. Illustrating by example, as shown in FIG. 3D the authorized user 301 of the electronic device 300 has launched a gaming application on the second companion electronic device 305. The authorized user 301 has oriented the electronic device 300 such that a medial line of the electronic device 300 is directed to the second companion electronic device 305.

At step 331, an orientation detector of the electronic device 300 detects this orientation. At step 332, one or more processors of the electronic device 300 obtain the mapping determined in FIG. 3B, adjust the size of the pointer, and move the pointer to the display of the second companion electronic device 305. The authorized user 301 of the electronic device 300 can then navigate the pointer by moving their finger across the display of the electronic device. In response to user input interacting with a “launch” user actuation target presented on the display of the electronic device 300 along with the universal control for the companion electronic devices 303,305,307, at step 333 the one or more processors can actuate a corresponding user actuation target on the second companion electronic device 305 to launch the gaming mode.

In some embodiments, the movement of the electronic device 300, as illustrated in FIG. 3D, can be utilized to move the pointer across the displays of companion electronic devices. However, in other embodiments, the movement of the pointer in accordance with the mapping may occur when the authorized user 301 simply moves their finger across the display 309 of the electronic device 300. This touch-based control allows for intuitive and direct manipulation of the pointer, enhancing user interaction. Additionally, the pointer may be controlled through other input methods, such as voice commands, gestures detected by sensors, or even eye-tracking technology, providing a versatile and adaptable user experience. It is noted that still other techniques for controlling the pointer will be apparent to those of ordinary skill in the art having the benefit of this disclosure, allowing for further customization and optimization of the user interface.

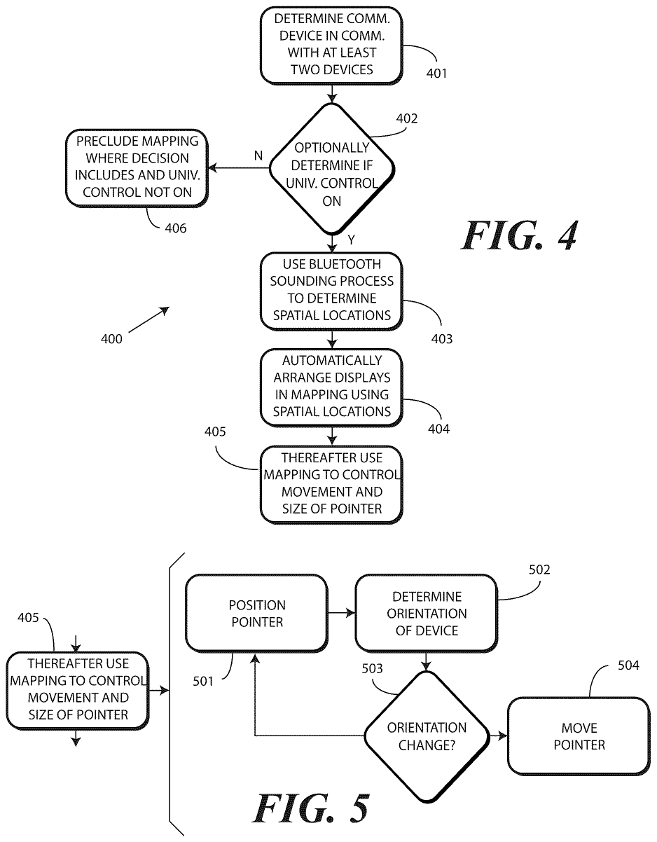

Turning now to FIG. 4, illustrated therein is another explanatory method 400 in accordance with one or more embodiments of the disclosure. In the method 400 of FIG. 4, step 401 involves determining, by one or more processors, that a communication device of the electronic device is electronically in communication with at least a first companion electronic device and a second companion electronic device, each situated within the environment of the electronic device.

This step can be performed using several techniques. One technique involves the use of Bluetooth discovery protocols, where the communication device actively scans for nearby Bluetooth-enabled devices and establishes a connection based on predefined pairing criteria. This method is advantageous due to its low power consumption and ability to maintain stable connections over short distances, making it ideal for environments where devices are in close proximity.

Another technique employs Wi-Fi Direct, which allows devices to connect directly without the need for a wireless access point. This method provides the advantage of higher data transfer rates and extended range, which is beneficial in environments where devices are spread out over a larger area. Additionally, Near Field Communication (NFC) can be used for initial pairing, leveraging its ease of use and quick setup time, which is particularly advantageous in scenarios requiring rapid and secure device connections. Each of these techniques offers distinct benefits, allowing for flexible and efficient management of device communications in various operational contexts.

As noted above, in some embodiments controlling the input control operable on the various companion electronic devices using the mapping only occurs when a universal control for the first companion electronic device and the second companion electronic device has been activated by a user. Optional decision 402 determines whether such a setting has been enabled. Where it has not, step 406 precludes the mapping operation.

However, when decision 402 is omitted or when the authorized user of the electronic device has enabled a universal control feature in an electronic device, step 403 comprises determining, by the one or more processors using a Bluetooth channel sounding process performed by the communication device, a location of, for example, a first companion electronic device relative to a second companion electronic device. This location mapping can continue for all companion electronic devices situated within the environment of the electronic device.

Step 404 then comprises automatically arranging, by the one or more processors, a mapping of a first display of the first companion electronic device and a second display of the second companion electronic device using the location of the first companion electronic device relative to the second companion electronic device. This arrangement can continue for all companion electronic devices situated within the environment of the electronic device.

In one or more embodiments, step 404 automatically arranges the mapping of the first display of the first companion electronic device and the second display of the second companion electronic device using the location of the first companion electronic device relative to the second companion electronic device into a bottom justified an arrangement of the first display of the first companion electronic device and the second display of the second companion electronic device.

However, it should be notified that defaulting to a bottom justified arrangement is just one option. In many embodiments, user settings can be used to define the default arrangement, be it bottom justified, top justified, stacked, or another arrangement. Moreover, in some embodiments the user is given the ability to adjust the default mapping.

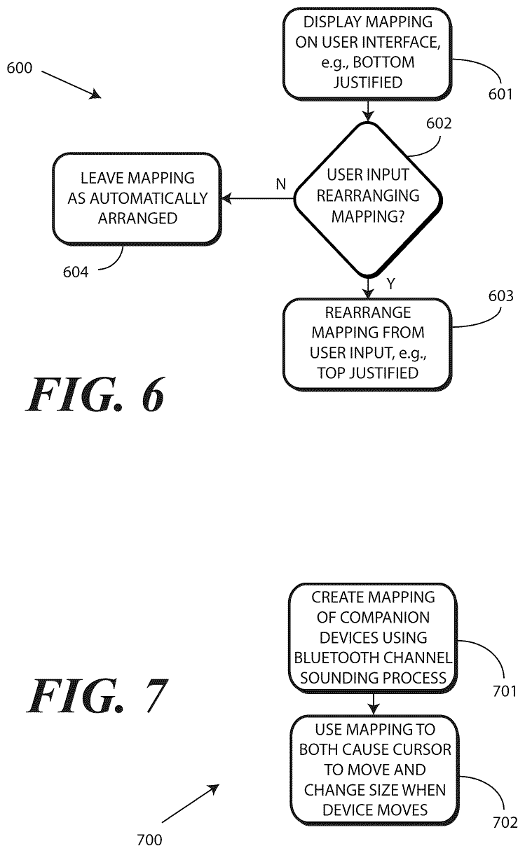

Illustrating by example, turning briefly to FIG. 6, at step 601 a method 600 has automatically arranged the mapping of the first display of the first companion electronic device and the second display of the second companion electronic device using the location of the first companion electronic device relative to the second companion electronic device by bottom justifying an arrangement of the first display of the first companion electronic device and the second display of the second companion electronic device. However, decision 602 determines whether user input has been received by the user interface rearranging the mapping the first display of the first companion electronic device and the second display of the second companion electronic device using the location of the first companion electronic device relative to the second companion electronic device. In one or more embodiments, decision 602 occurs while the mapping is being presented on the user interface.

Where such input is received, step 603 comprises rearranging, by the one or more processors, the mapping in accordance with the user input to create a user defined mapping. Illustrating by example, the user defined mapping may comprise a top justified arrangement of the first display of the first companion electronic device and the second display of the second companion electronic device. Otherwise, the default mapping remains at step 604.

Turning now back to FIG. 4, step 405 then comprises controlling, by the one or more processors, an input control operable on both the first companion electronic device and the second companion electronic device using the mapping. In one or more embodiments, the input control comprises a pointer. In another embodiment, the input control comprises a cursor. In still other embodiments, the input control comprises a magnifying glass.

Thus, at step 405 of FIG. 4, the mapping determined at step 404 can be utilized to control various input controls, enhancing the versatility and functionality of the electronic device. One such input control is a pointer, which can be seamlessly moved across multiple displays, allowing users to interact with different devices as if they were a single, unified interface. This is particularly useful in scenarios where a user needs to manage tasks across a computer and a tablet, such as dragging and dropping files or navigating between applications.

Another input control is a cursor, which can be used for precise selection and editing tasks, making it ideal for graphic design or document editing where accuracy is critical. Additionally, a magnifying glass input control can be employed to zoom in on specific areas of a display, aiding users in detailed inspection tasks, such as reviewing high-resolution images or scrutinizing complex data sets. Each of these input controls leverages the spatial mapping to provide a fluid and intuitive user experience, eliminating the need for manual configuration and ensuring continuous operability across multiple devices.

Turning now to FIG. 5, illustrated therein is one explanatory method that can be used at step 405. The technique described in FIG. 5 moves the input control in response to movement of the electronic device. As noted above, this is but one option for moving the input control. Touch input, voice input, gaze, or other techniques can be used as well.

At step 501, one or more processors position the input control at an initial or default position. In one or more embodiments, step 502 then comprises determining, by the one or more processors from signals received from an orientation detector, an orientation of the electronic device in three-dimensional space. Decision 503 then determines whether there has been a change in orientation of the electronic device. Where there has, step 504 comprises causing, by the one or more processors, the pointer to appear to move in accordance with the mapping from the first display of the first companion electronic device to the second display of the second companion electronic device (presuming two companion electronic devices - if more, the input control could move in other ways as well).

Step 504 can include the performance of other operations as well. Illustrating by example, in one or more embodiments step 504 comprises also causing, by the one or more processors, a resizing of the pointer in accordance with the mapping when the pointer moves from the first display of the first companion electronic device to the second display of the second companion electronic device. In one or more embodiments, control of the input control operable on both the first companion electronic device and the second companion electronic device using the mapping repeats at step 504 with each orientation change determined by decision 503 without repeating the determining the location of the first companion electronic device relative to the second companion electronic device. This omission of remapping can continue until movement, removal, or an addition of a companion electronic device is detected in one or more embodiments.

Turning now to FIG. 7, illustrated therein is another explanatory method 700 in accordance with one or more embodiments of the disclosure. Beginning at step 701, the method 700 comprises creating, by one or more processors, a mapping of at least a first display of a first companion electronic device and a second display of a second companion electronic device using a Bluetooth channel sounding process to determine a location of the first companion electronic device relative to the second companion electronic device. This step 701 allows for the automatic configuration of monitor arrangements, eliminating the need for manual adjustments when devices are repositioned.

As noted above, step 701 can result in the mapping being arranged in accordance with a default setting. Illustrating by example, as shown in FIG. 3B, in one or more embodiments the mapping abuts a representation of a first display of the first companion electronic device against a representation of a second display of the second companion electronic device with at least one side of both the representation of the first display and the representation of the second display defining a contiguous line. In FIG. 3B, the bottom sides of the representation of the first display and the representation of the second display define the contiguous line because the arrangement is bottom justified. In other embodiments, the top side of the representation of the first display and the representation of the second display will define the contiguous line if the arrangement is top justified.

If the arrangement is stacked and left justified, the left sides of the representation of the first display and the representation of the second display will define the contiguous line. If the arrangement is tacked and right justified, the right sides of the representation of the first display and the representation of the second display will define the contiguous line. Other arrangements will be obvious to those of ordinary skill in the art having the benefit of this disclosure.

At step 702, the method comprises using, by the one or more processors, the mapping to both cause the cursor to move from the first companion electronic device to the second companion electronic device in response to movement of the electronic device and to change a size of the cursor when the cursor moves from the first companion electronic device to the second companion electronic device.

The inventor highlighted a use case where a mouse can seamlessly interact with a tablet, phone, and computer, allowing the cursor to pass from one device to the next as if they were natively connected. This innovative approach not only simplifies the user experience but also enhances productivity by ensuring continuous operability across multiple devices without the need for manual intervention

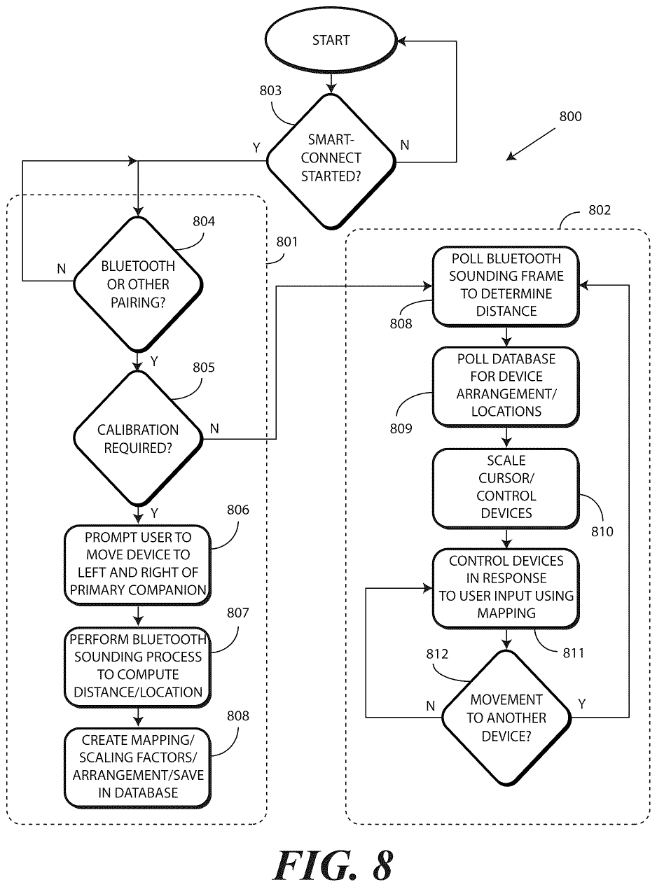

Turning now to FIG. 8, illustrated therein is another explanatory method 800 in accordance with one or more embodiments of the disclosure. The method 800 of FIG. 8 provides a comprehensive process designed to manage the relative positioning of electronic devices using Bluetooth channel sounding. Generally speaking, the method 800 is divided into an initialization and calibration phase 801 and an autodetection phase 802.

In one or more embodiments, the autodetection and calibration phase 801 of the method 800 of FIG. 8 is performed when the electronic device initially pairs with companion devices or when a significant change in the environment is detected, such as the addition of a new device or a substantial repositioning of existing devices. For instance, when a user introduces a new tablet to a setup involving a laptop and a smartphone, the calibration phase is triggered to accurately map the relative positions of all devices. On the other hand, this autodetection and calibration phase 801 may not be performed if the devices have already been calibrated and remain in their original positions without any new additions or significant movements.

Meanwhile, the autodetection phase 802 can be continuously active to monitor minor adjustments in device positioning, such as when a user slightly shifts a smartphone on a desk. This autodetection phase 802 ensures that the mapping remains accurate, and the user experience seamless. However, the autodetection phase 802 may not be performed if the devices are powered off or if the Bluetooth connection is lost, as the system would lack the necessary data to detect changes in positioning. Thereafter, the autodetection and calibration phase 801 may again be performed.

In one or more embodiments, the method 800 begins with optional decision 803, which checks whether a universal control feature, one example of which was the Smart-Connect feature from FIG. 1, has been initiated. Where included this decision 803 ensures that the system is ready to establish communication between the primary device and its companion devices. If decision 803 is included the Smart-Connect feature is not started, in one or more embodiments the process does not proceed.

In the autodetection and calibration phase 801, decision 804 involves determining whether Bluetooth or another form of pairing has been established between the primary device and companion devices. This Decision 804 sets up the communication channel necessary for the Bluetooth channel sounding process. The pairing process ensures that the devices are within the effective range for communication and that a secure connection is established.

Decision 805 checks if calibration is required. In one or more embodiments, calibration is a one-time or limited frequency setup process that involves determining the relative positions of the companion devices in relation to the primary device. Calibration is beneficial in ensuring accurate distance measurements and spatial awareness, which are important for the subsequent mapping and control processes.

Where calibration is required, step 806 prompts the user to move the companion device to the left and right of the primary device. This user interaction is part of the calibration process, allowing the system to compute the range between the devices using Bluetooth channel sounding. The user is asked to confirm these placements to ensure accurate calibration.

Step 807 involves performing the Bluetooth sounding process to compute the distance and location of the companion devices relative to the primary device. This step leverages the fixed location of the Bluetooth chip within the primary device to measure the distance with high accuracy. The computed distances are then tagged as “Left” or “Right,” which are used in the mapping process.

Step 808 creates a mapping of the device arrangement and saves this information in a database. This mapping includes scaling factors and arrangement details that are used to control the input devices across the companion devices. The mapping plays a role in ensuring seamless interaction and control across the displays of the companion devices.

Where calibration is complete or otherwise not required, decision 805 moves the method to the autodetection phase 802. In one or more embodiments, the autodetection phase begins at step 809, which involves polling the Bluetooth sounding frame to determine the distance between the devices. This step 809 is part of the autodetection phase 802, where the system continuously monitors the distances to detect any displacement of the companion devices. The polling process ensures that the mapping remains accurate and up to date.

Step 810 scales the cursor and controls the devices based on the mapping created in step 808. This step ensures that the input control, such as a mouse or cursor, operates seamlessly across the companion devices. The scaling process adjusts the size and movement of the cursor to match the relative positions of the devices.

Step 811 controls the devices in response to user input using the mapping. This step allows the user to interact with the companion devices as if they were a single, unified interface. The mapping ensures that the input control moves smoothly across the displays, enhancing the user experience.

Decision 812 checks if there is movement to another device. This step is part of the autodetection phase 802, where the system monitors for any changes in the relative positions of the devices. If movement is detected, the system updates the mapping and adjusts the input control accordingly to maintain seamless interaction.

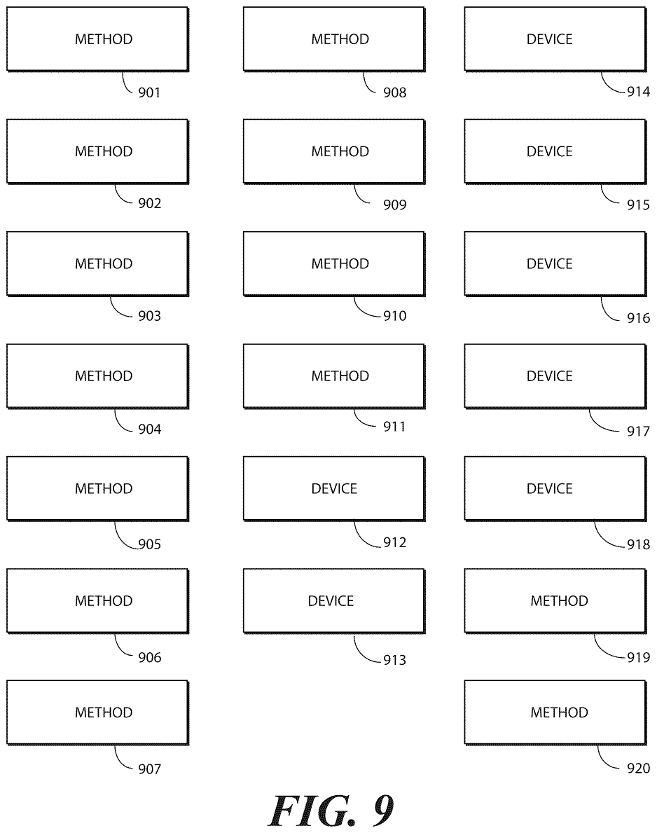

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated and described, their repeated illustration is no longer essential for a proper understanding of these embodiments. Thus, the embodiments are shown as labeled boxes.

At 901, a method in an electronic device comprises determining, by one or more processors, that a communication device of the electronic device is electronically in communication with at least a first companion electronic device and a second companion electronic device each situated within an environment of the electronic device. At 901, the method comprises determining, by the one or more processors using a Bluetooth channel sounding process performed by the communication device, a location of the first companion electronic device relative to the second companion electronic device.

At 901, the method comprises automatically arranging, by the one or more processors, a mapping of a first display of the first companion electronic device and a second display of the second companion electronic device using the location of the first companion electronic device relative to the second companion electronic device. At 901, the method comprises controlling, by the one or more processors, an input control operable on both the first companion electronic device and the second companion electronic device using the mapping. At 902, the input control of 901 comprises a pointer.

At 903, the method of 901 further comprises determining, by the one or more processors from signals received from an orientation detector, a change in orientation of the electronic device. At 903, the method further comprises causing, by the one or more processors, the pointer to appear to move in accordance with the mapping from the first display of the first companion electronic device to the second display of the second companion electronic device.

At 904, the method of 903 further comprises also causing, by the one or more processors, a resizing of the pointer in accordance with the mapping when the pointer moves from the first display of the first companion electronic device to the second display of the second companion electronic device. At 905, the automatically arranging the mapping of the first display of the first companion electronic device and the second display of the second companion electronic device using the location of the first companion electronic device relative to the second companion electronic device of 901 comprises bottom justifying an arrangement of the first display of the first companion electronic device and the second display of the second companion electronic device.

At 906, the controlling the input control of 901 operable on both the first companion electronic device and the second companion electronic device using the mapping occurs only when a universal control for the first companion electronic device and the second companion electronic device has been activated. At 907, the control of the input control of 901 operable on both the first companion electronic device and the second companion electronic device using the mapping repeats without repeating the determining of the location of the first companion electronic device relative to the second companion electronic device.

At 908, the method of 901 further comprises causing, by the one or more processors, a user interface of the electronic device to display the mapping of the first display of the first companion electronic device and the second display of the second companion electronic device. At 909, the method of 908 further comprises receiving, by the user interface, user input rearranging the mapping of the first display of the first companion electronic device and the second display of the second companion electronic device using the location of the first companion electronic device relative to the second companion electronic device while the mapping is being presented on the user interface. At 909, the method further comprises rearranging, by the one or more processors, the mapping in accordance with the user input to create a user-defined mapping.

At 910, the user-defined mapping of 909 comprises a top justified arrangement of the first display of the first companion electronic device and the second display of the second companion electronic device. At 911, the determining the location of the first companion electronic device relative to the second companion electronic device by the communication device of 910 comprises performing the Bluetooth channel sounding process with an asymmetrically positioned Bluetooth module situated in one of the first companion electronic device or the second companion electronic device.

At 912, an electronic device comprises a communication device and one or more processors operable with the communication device. At 912, the one or more processors are configured to cause the communication device to perform a Bluetooth channel sounding process with a first Bluetooth module asymmetrically situated in a first companion electronic device and a second Bluetooth module situated in a second companion electronic device to determine a location of one of the first companion electronic device or the second companion electronic device relative to another of the first companion electronic device or the second companion electronic device. At 912, the one or more processors create a mapping of a first display of the first companion electronic device and a second display of the companion electronic device using the location. At 912, the one or more processors control a pointer using the mapping.

At 913, the first Bluetooth module of 912 is asymmetrically situated in the first companion electronic device. At 913, the one or more processors are configured to determine that the location of the first companion electronic device is to the left or the right of the second companion electronic device when a distance between the first Bluetooth module and the second Bluetooth module is greater than half of a diameter of the first companion electronic device.

At 914, the first Bluetooth module of 913 is situated in a left side of the first companion electronic device. At 914, the one or more processors are configured to determine that the location of the first companion electronic device is to the left of the second companion electronic device when the distance between the first Bluetooth module and the second Bluetooth module is greater than half of the diameter of the first companion electronic device.

At 915, the electronic device of 912 further comprises a user interface. At 915, the one or more processors are further configured to cause the user interface to present a prompt instructing a user to orient the electronic device to the left and to the right of the first companion electronic device while the Bluetooth channel sounding process is occurring.

At 916, the one or more processors of 912 are further configured to change a size of the pointer using the mapping when moving the pointer from the first companion electronic device to the second companion electronic device or vice versa. At 917, the system within which the electronic device operates further comprises the first companion electronic device and the second companion electronic device. At 918, the first companion electronic device of 917 comprises a computer and the second companion electronic device comprises one of a tablet computer or a smartphone.

At 919, a method in an electronic device comprises creating, by one or more processors, a mapping of at least a first display of a first companion electronic device and a second display of a second companion electronic device using a Bluetooth channel sounding process to determine a location of the first companion electronic device relative to the second companion electronic device. At 919, the method comprises using, by the one or more processors, the mapping to both cause the cursor to move from the first companion electronic device to the second companion electronic device in response to movement of the electronic device and to change a size of the cursor when the cursor moves from the first companion electronic device to the second companion electronic device.

At 920, the mapping of 919 abuts a representation of a first display of the first companion electronic device against a representation of a second display of the second companion electronic device with at least one side of both the representation of the first display and the representation of the second display defining a contiguous line.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in various embodiments of the electronic device described, the communication device and processors are configured to perform a Bluetooth channel sounding process with asymmetrically situated Bluetooth modules in companion electronic devices. In one embodiment, the first Bluetooth module is positioned on the left side of a laptop, allowing the system to determine the relative position of a smartphone placed to the right of the laptop. This configuration enables the processors to create a mapping of the displays, facilitating seamless pointer control across devices.

In another embodiment, the first Bluetooth module is integrated into a tablet, positioned at the top edge, which allows the system to ascertain the position of a desktop computer situated below the tablet. This setup is particularly useful in a vertical display arrangement, where the pointer can move smoothly from the tablet's display to the desktop's monitor.

Additionally, the processors may be configured to adjust the pointer's size dynamically based on the display size of each companion device, ensuring optimal visibility and user experience. The system can also prompt users via a user interface to confirm device orientations during the initial setup, enhancing the accuracy of the mapping process. These embodiments demonstrate the adaptability of the system in various device configurations and environments, ensuring efficient and intuitive multi-device interaction.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
determining, by one or more processors, that a communication device of the electronic device is electronically in communication with at least a first companion electronic device and a second companion electronic device each situated within an environment of the electronic device;
determining, by the one or more processors using a Bluetooth channel sounding process performed by the communication device, a location of the first companion electronic device relative to the second companion electronic device;
automatically arranging, by the one or more processors, a mapping of a first display of the first companion electronic device and a second display of the second companion electronic device using the location of the first companion electronic device relative to the second companion electronic device; and
controlling, by the one or more processors, an input control operable on both the first companion electronic device and the second companion electronic device using the mapping.

2. The method of claim 1, wherein the input control comprises a pointer.

3. The method of claim 2, further comprising:
determining, by the one or more processors from signals received from an orientation detector, a change in orientation of the electronic device; and
causing, by the one or more processors, the pointer to appear to move in accordance with the mapping from the first display of the first companion electronic device to the second display of the second companion electronic device.

4. The method of claim 3, further comprising also causing, by the one or more processors, a resizing of the pointer in accordance with the mapping when the pointer moves from the first display of the first companion electronic device to the second display of the second companion electronic device.

5. The method of claim 1, wherein the automatically arranging the mapping of the first display of the first companion electronic device and the second display of the second companion electronic device using the location of the first companion electronic device relative to the second companion electronic device comprises bottom justifying an arrangement of the first display of the first companion electronic device and the second display of the second companion electronic device.

6. The method of claim 1, wherein the controlling the input control operable on both the first companion electronic device and the second companion electronic device using the mapping only occurs when a universal control for the first companion electronic device and the second companion electronic device has been activated.

7. The method of claim 1, wherein the controlling the input control operable on both the first companion electronic device and the second companion electronic device using the mapping repeats without repeating the determining the location of the first companion electronic device relative to the second companion electronic device.

8. The method of claim 1, further comprising causing, by the one or more processors, a user interface of the electronic device to display the mapping of the first display of the first companion electronic device and the second display of the second companion electronic device.

9. The method of claim 8, further comprising:
receiving, by the user interface, user input rearranging the mapping the first display of the first companion electronic device and the second display of the second companion electronic device using the location of the first companion electronic device relative to the second companion electronic device while the mapping is being presented on the user interface; and
rearranging, by the one or more processors, the mapping in accordance with the user input to create a user defined mapping.

10. The method of claim 9, wherein the user defined mapping comprises a top justified arrangement of the first display of the first companion electronic device and the second display of the second companion electronic device.

11. The method of claim 10, wherein the determining the location of the first companion electronic device relative to the second companion electronic device comprises the communication device performing the Bluetooth channel sounding process with an asymmetrically positioned Bluetooth module situated in one of the first companion electronic device or the second companion electronic device.

12. An electronic device, comprising:
a communication device; and
one or more processors operable with the communication device;
wherein the one or more processors are configured to cause the communication device to perform a Bluetooth channel sounding process with a first Bluetooth module asymmetrically situated in a first companion electronic device and a second Bluetooth module situated in a second companion electronic device to determine a location of one of the first companion electronic device or the second companion electronic device relative to another of the first companion electronic device or the second companion electronic device, create a mapping of a first display of the first companion electronic device and a second display of the second companion electronic device using the location, and control a pointer using the mapping.

13. The electronic device of claim 12, wherein:
the first Bluetooth module is asymmetrically situated in the first companion electronic device; and
the one or more processors are configured to determine that the location of the first companion electronic device is to the left or the right of the second companion electronic device when a distance between the first Bluetooth module and the second Bluetooth module is greater than half of a diameter of the first companion electronic device.

14. The electronic device of claim 13, wherein:
the first Bluetooth module is situated in a left side of the first companion electronic device; and
the one or more processors are configured to determine that the location of the first companion electronic device is to the left of the second companion electronic device when the distance between the first Bluetooth module and the second Bluetooth module is greater than the half of the diameter of the first companion electronic device.

15. The electronic device of claim 12, further comprising a user interface, wherein the one or more processors are further configured to cause the user interface to present a prompt instructing a user to orient the electronic device to the left and to the right of the first companion electronic device while the Bluetooth channel sounding process is occurring.

16. The electronic device of claim 12, wherein the one or more processors are further configured to change a size of the pointer using the mapping when moving the pointer from the first companion electronic device to the second companion electronic device or vice versa.

17. The electronic device of claim 12, further comprising the first companion electronic device and the second companion electronic device.

18. The electronic device of claim 17, wherein the first companion electronic device comprises a computer and the second companion electronic device comprises one of a tablet computer or a smartphone.

19. A method in an electronic device, the method comprising:
creating, by one or more processors, a mapping of at least a first display of a first companion electronic device and a second display of a second companion electronic device using a Bluetooth channel sounding process to determine a location of the first companion electronic device relative to the second companion electronic device; and
using, by the one or more processors, the mapping to both cause a cursor to move from the first companion electronic device to the second companion electronic device in response to movement of the electronic device and to change a size of the cursor when the cursor moves from the first companion electronic device to the second companion electronic device.

20. The method of claim 19, wherein the mapping abuts a representation of a first display of the first companion electronic device against a representation of a second display of the second companion electronic device with at least one side of both the representation of the first display and the representation of the second display defining a contiguous line.
